(19) United States
(12) Patent Application Publication
(10) Pub. No.: US 2004/0051732 A1
(43) Pub. Date: Mar. 18, 2004

(54) Digital project management system

(75) Inventors: Geoffrey C. White, Los Angeles, CA (US); Lisa C. White, Los Angeles, CA (US); Mark Meloccaro, Burbank, CA (US)

Correspondence Address: LAW OFFICES OF KAMRAN FATTAHI, 6345 BALBOA BLVD, SUITE 330 (BLDG. 2), ENCINO, CA, 91316, US

(73) Assignee: La Classe Locations, Inc.

(21) Appl. No.: 10/611,541

(22) Filed: Jul. 1, 2003

Related U.S. Application Data
(60) Provisional application No. 60/393,432, filed on Jul. 2, 2002.

(51) Int. Cl. G09G 5/00

(52) U.S. Cl. 345/736

(57) ABSTRACT

The present invention provides a large database of electronic media related to locations that may be selected and formed into a virtual media booklet by users. The system automates the search, preparation, presentation, and delivery to users all requested information for a site, for eventual automated review of the delivered content. Designed as a presentation and distribution system of content, the system comes in a web based or stand-alone version. It allows authorized users to view the result of their search orders, organize, and create a virtual screen room for further filtering of content. The Digital Desktop Application also provides a virtual image processing center that enables authorized users the ability to provide a hard copy of any selected location information, if the so desired.

### CROSS-REFERENCE TO RELATED APPLICATIONS

The present application claims priority from related U.S. Provisional Patent Application Serial No. 60/393,432, filed Jul. 2, 2002, the entire disclosure of which is incorporated herein by reference.

### BACKGROUND OF THE INVENTION

(1) Field of the Invention

The present invention relates to project management methods, and more particularly, to a digital project management system.

(2) Description of Related Art

Location scouting is the business of locating a site for filming, photography, music videos, or other related projects based on scenic or “story line” requirements of that project. A location scout's client may for example request a search for a filming location that includes an apartment complex next to a large body of water such as lake, be available on a specified date and hours, with reasonable fee arrangements with the owner of the site, including reasonable permit requirements for any jurisdictional ordinances.

In general, to expedite their searches most location scouts will start their work by consulting a manually complied database that contains thousands of 8.5 inch by about 5 inch paper file cards classified by subject matter. The scout would search through the cards for one or more locations with required settings. Most file cards comprise a photograph of a location and information about that site. The information may include an address of the photographed location, a contact person (usually the owner), a brief description of the location, the time and date the photograph was taken, and other relevant information that may be of interest to both location scouts and their clients. Upon locating the appropriate site on one or more cards, the scout uses the information thereon for further investigation of the sites. This may include contacting the location owner for condition and availability of the site, a visit to locations, and any other requirements specified by a client, such as obtaining permit information, appropriate fee arrangements with site management, etc.

There are instances when location scouts cannot find a client's required site on any file card, or if found, the information thereon is outdated. For example, the owner may have sold the property, the property photographed may no longer exists, or does not have the same condition as shown in the photograph. In such cases the location scout reverts to cold-scouting—a well-known term referring to consulting telephone directories or any other source of information that will guide the scout in finding the requested location.

A typical successful search using the classified file card system may take several days from start to completion—even if the card contains updated information. After completing a search, visiting the site and collecting all the information requested by the client, scouts forward the assembled facts to the client for review. This may include all the new photo shots or any newly updated information about the site—such as the new owner information, jurisdictional ordinance requirements for times allowed for filming, permits, licenses, etc.

As is apparent from the above description, location scouting is very labor intensive and extremely time consuming—even with updated information available on the file cards. Given the physical dimensions of each card, it would not seem possible to add more information about each site to expedite the overall search process for the scout. For example, no room is available to place a driving direction to the photographed addresses on the cards. The scout must look-up a map to find the driving direction for those addresses. The cards do not have enough room for information regarding jurisdictional ordinances. This compels the scout to spend time in contacting the appropriate departments of that jurisdiction for ordinance information—a very time consuming task that involves looking up telephone directories for the telephone numbers of those departments, and looking up maps to find the location of those departments. Even when found, the scout may have to drive to those departments to obtain the appropriate forms for filming permits, licenses, etc. The difficulty multiplies if each form is located at a different department that is physically located at a different area of the jurisdiction.

A location scout faces all the above-described exemplary difficulties for most projects. The difficulties multiply when a client requests searches for two or more locations. The scout must perform the same steps for each location. This includes the collection of information (e.g. photo-shots, addresses, permits, etc.), preparation (organizing of the information collected), and forwarding of all facts to client for each request.

The organizing and forwarding of collected information is yet another time consuming, labor intensive task performed by scouts for each project. For example, all location photo-shots must be assembled in an order that portrays the “story-line” image the client intended for the project. In addition, the addresses of all locations and their respective contact person must also be available to the client. Furthermore, all jurisdictional ordinance information with respect to every jurisdiction of interest can accompany the completed file when forwarded to the client. Scouts manually organize all information using “paper, gluesticks and tape” to create a paper folder to forward to clients.

In addition to the difficulties described, scouts must also maintain and expand the manual file cards system in order to continue to expedite searches for locations. In general, updates of cards are done randomly, on a case-by-case basis, when used. If not used, the information thereon will remain as such until a need arises to use that card.

### BRIEF SUMMARY OF THE INVENTION

The present invention is comprised of software applications and databases that allow for automation of most tasks performed by traditional scouting methods, providing efficient production tools for users. The present invention comprises a large database of electronic media related to locations that may be selected and formed into a virtual media booklet by users. The system automates the search, preparation, presentation, and delivery to clients all requested information for a site, for eventual automated review of the delivered content.

Designed as a presentation and distribution system of the electronic media, the system comes in a web based or stand-alone version. The system streamlines the traditional methods of acquiring location information for productions, and efficiently communicates that information to others involved. In general, the system comprises a recorder unit that allows users to manage the automated database. The system also enables access to various consultants with expertise in the content of the automated database, and allows for automated delivery of its content.

In addition, the system also includes a Digital Desktop Application that allows an authorized end-user to view the result of their search orders and organize and create a virtual screening room for further filtering of content. The Digital Desktop Application also provides a virtual image processing center that enables authorized users the ability to provide a hard copy of any selected location information, if the client desires.

If end-users wish to incorporate the capabilities of the software application of the present invention on their own web site, then a web-site may be created powered by the system of the present invention where the users may include their own company logo and contact information, in addition to those provided by the system of the present invention.

These and other features, aspects, and advantages of the invention will be apparent to those skilled in the art from the following detailed description of preferred non-limiting embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention.

Referring to the drawings in which like reference numbers present corresponding parts throughout:

FIG. 1 is an exemplary systems view illustration in accordance with one embodiment of present invention;

FIG. 2 is an exemplary block diagram illustrating the Digital Desktop Application resources available in accordance with one embodiment of the present invention;

FIG. 3 is a flow diagram illustrating an exemplary procedure for the process of initiated a new end-user account in accordance with one embodiment of the present invention;

FIG. 4 is a flow diagram illustrating an exemplary procedure for the method of processing and completing orders received from end-users in accordance with one embodiment of the present invention;

FIG. 5 is a flow diagram illustrating an exemplary procedure for the processes of initiating a new user account in accordance with a second embodiment of the present invention;

FIG. 6 is an exemplary block diagram illustrating the Digital Desktop Application resources available in accordance with a second embodiment of the present invention;

FIG. 7 is an exemplary block diagram illustrating the use of the applications of the present invention on an individual's web-site in accordance with a third embodiment of the present invention.

### DETAILED DESCRIPTION OF THE INVENTION

For purposes of illustration, programs and other executable program components are illustrated herein as discrete blocks, although it is recognized that such programs and components may reside at various time in different storage components, and are executed by the data processor(s) of the computers.

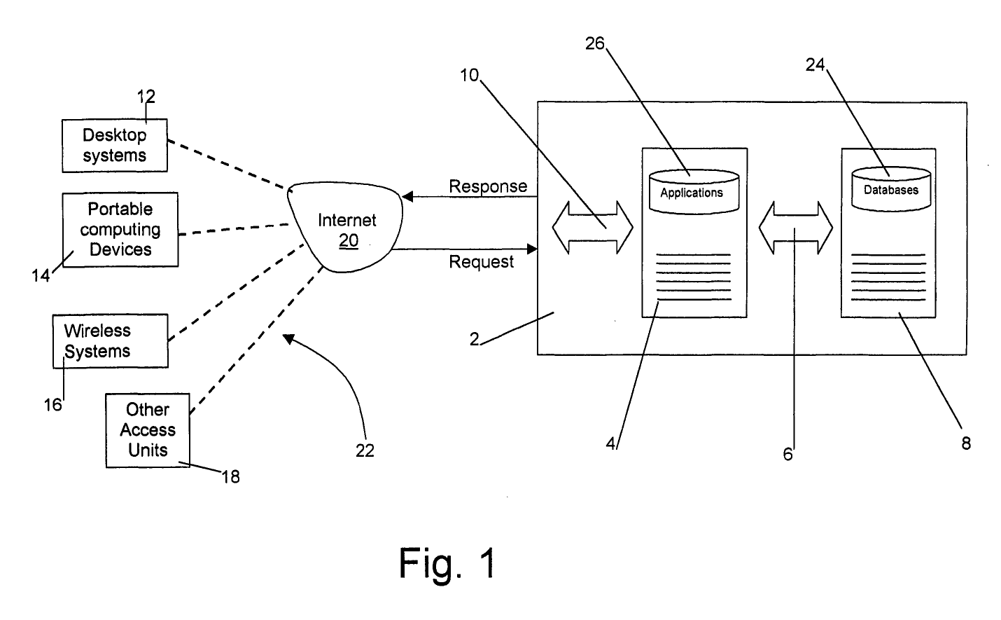

FIG. 1 is an exemplary illustration of a general overview of the system, its web-based Digital Desktop Application, databases, and connection to various user access units 12-18, in accordance with one embodiment of the present invention. Although only two servers 4 and 8 are illustrated for simplicity, it should be understood that any number of servers and backup units may be used for each application and or database. In addition, a single server may also house both the applications 26 and the databases 24. As illustrated, end-users may access system 2 through a presentation code displayed by users' browsers on a desktop 12, a portable computing device such as a laptop 14, wireless systems such as a Personal Data Assistance (PDAs), or any other access units 18 available to view, place orders, or perform other functions. In general, the user may communicate by a variety of protocols 22 for accessing system 2. This may include an unsecured connection such as for example a HyperText Transfer Protocol (HTTP) or a secure one such as a Secure Sockets Layer (SSL). SLL is an encryption protocol applied to HTTP traffic to ensure integrity and privacy, through connection 10. With this illustration, the users may represent a location scout, the scout's client, a consultant, or others interested in management and distribution of products, each authorized with different levels of access privileges to system 2. Access for “in-house” staff is via the Internet and access for the hosting company is via the Internet and/or direct database access.

The overall process commences when users place their search orders through access units 12-18. Consultants process the orders and an instance of a Digital Desktop Application for that order forwards to the user account. The consultants can authorize accounts, search the database 24, and add content to the Digital Desktop Applications available to authorized users. Users are informed by an appropriate method (selected by the users when creating an account to place an order) regarding the completion of the search orders. A location scout or others interested in finding a location for filming are no longer required to consult outdated paper file cards that contain inadequate information even if not outdated. In addition, with this embodiment the users need not be familiar with the database 24. They simply place requests with consultants, who are familiar with the database and will perform the search quickly to find desired locations, including updated information, maps, and other information relevant to users.

The relational database 24 includes all relevant media content for end-users. The database 24 may comprise of any industry standard relational database system, including, but not limited to, for example, Oracle, MySQL, SQL Servers, or any others that enables efficient management, manipulation, and distribution of data. The database 24 may run on servers 8 using any industry standard operating system, including, but not limited to, for example, Linux, Windows NT, Unix or others. The physical connection to the servers 4 and 8 is by industry standard methods, including for example the use of Ethernet cards to access them. In general, relational databases represented, do not directly communicate with applications 26. In order to establish a communication link 6 between an application 26 and the relational database 24, various industry standard application programming interfaces (API) such as, for example, Open Database Connectivity (ODBC), MyODBC (for MySQL databases), JDBC (for Java based systems), or others may be used. Each API is designed specifically to access and expose features of its corresponding connected relational database store to authorized users according to predefined parameters. These may include, but should not be limited to, for example, specific security configurations, IP addresses, port numbers, and other standard changes specific for the location and requirements of the system.

The relational database 24 is comprised of one or more tables of data “related or linked” together through well-known database programming principles, including the use of primary and foreign keys—a capability inherent in most relational database systems. In general, a primary key identifies one or more columns whose values uniquely identify a single row of data in a table. In general, the database automatically generates the unique values associated with primary keys. Foreign keys in a relational database represent values that point to a primary key in another table. A foreign key in one table points to an exact row of data in another table. Relational databases 24 are built using well-known normalization techniques—a process of eliminating duplicate data and providing a fast, efficient search path to it. The presentation code (part of the web-based Digital Desktop Application 26), using well-known database programming techniques, dynamically builds industry standard Structured Query Language (SQL) procedures to retrieve data therefrom. SQL is the language understood by most relational database systems, comprised of statements (or procedures) written in specific syntax that enable communication between programs, end-users, and the database. SQL uses key terms in a query to link or relate one or more tables using the primary and foreign keys associated with specific rows in those tables to create a virtual table (known as a view) containing a record-set (the “answer”) to the query.

Access to the relational databases 24 are secure, and hence privileged, limited to only authorized personnel. The roles or job functions of users dictate the type of access levels (varying privileges) they will receive. Each time a new user is added to the system, the system administrator must define a corresponding role for that user to enable that user to have the appropriate access level to the database, commensurate with the user functions (roles). Although the system allows for a plurality of roles for a plurality of users, one embodiment of the present invention uses four roles or functions to enable four levels of access to the database.

One role is allotted to recorders who have the function of managing the content of the databases 24. This may include, but is not limited to, for example, uploading new images, uploading new content such as location information regarding an image, creating new categories or keywords, searching the database, etc. The recorders are also responsible for the content and comprehensive management of the database 24. That is, they may categorize, subcategorize, assign a hero (main) content, and add detailed information in the database. Once constructed, the database becomes the storing system for all the information used throughout the site.

Content added to one or more tables of the database is also cross-referenced with other elements in one or more other tables. When content information is stored in one or more separate and distinct tables, the database assigns unique ID values (primary keys) to each row of data added to those tables. In general, the designers of most relational databases also create one or more “link” tables that contain the primary keys from those tables, linking them by using these keys. The structural design of all tables in a relational database, including the link tables, must meet the requirements set forth by the users of the database.

In addition to content, recorders may also add, delete, and edit user accounts and preferences to those accounts. All user accounts preferences or any other information using the database is stored in their respective tables, “linked” to one another in a predefined manner using “link tables”. The recorders are also able to report transactions (and hence keep track) of the individual accounts and users. The recorders may also create a statistical reporting of all activity on the site, and have access to the comprehensive reporting of the client's usage of the system. This will assist in the marketing of information.

A second role or function for authorized access to the database 24 is created for consultants. Consultants handle user requests by searching the database and forwarding the searched content to user web-based Digital Desktop Application 26. Administrators of the database, applications, and the entire system take on the third role. The administrator is in general responsible for managing all users. This responsibility may include, but is not limited to, for example, updating users to the system (deleting, viewing, adding, etc.), modifying end-user information profiles—including (adding, deleting, or changing) the roles of users, their passwords, etc. The administrator functions with respect to the applications are to maintain all applications 26 and their interfaces, including, but not limited to, for example, modifying resources already available to all users or other relevant information. Finally, this embodiment allots a fourth role or function to general users who have limited access to the front-end portion of web-based Digital Desktop Application 26, but no access to the databases. These users may include clients of a location scouts, other scouts, or others interested in using the system.

Web-based version of the Digital Desktop Application 26 is a Graphic User Interface (GUI) program (presentation code or logic) that enables consultants to have access to different parts of the relational database 24. It also provides all users with tools to perform a variety of tasks. Any version of the Digital Desktop Application programs may execute on any appropriate hardware, and are not limited to the use of desktops. Hence, the term “Desktop” should not be interpreted in its literal sense, and may be construed as any access units 12 to 18 represented in FIG. 1.

Although written in Active Server Pages (ASP) using a scripting language, the presentation code may be written in other well-known (non-scripting) programming languages and without the use of ASP. In addition, the actual SQL statements may be dynamically built and executed directly from the ASP or in the relational database 24. ASP pages provide a server-side scripting environment and allow the use of variables with session scope—a session may commence with creation of a new account and may have a limited duration. Hence, variables with a session scope may retain their values for the entire session. A server computer such as those illustrated in FIG. 1 interprets and executes any server-side script on the ASP page before it sends the file to the client-side (the user browser), with the result that the client receives a plain Hyper Text Markup Language (HTML) page. Typically, an Active Server Page will consist of sections of ASP script and plain HTML. ASP search engine dynamically generates an HTML stream from the contents of the ASP pages requested by a user, and forwards the resulting stream on to the browser. The use of ASP pages as GUI interfaces in connection with the database systems and forwarding of information to user browsers is well known and taught in many programming publications.

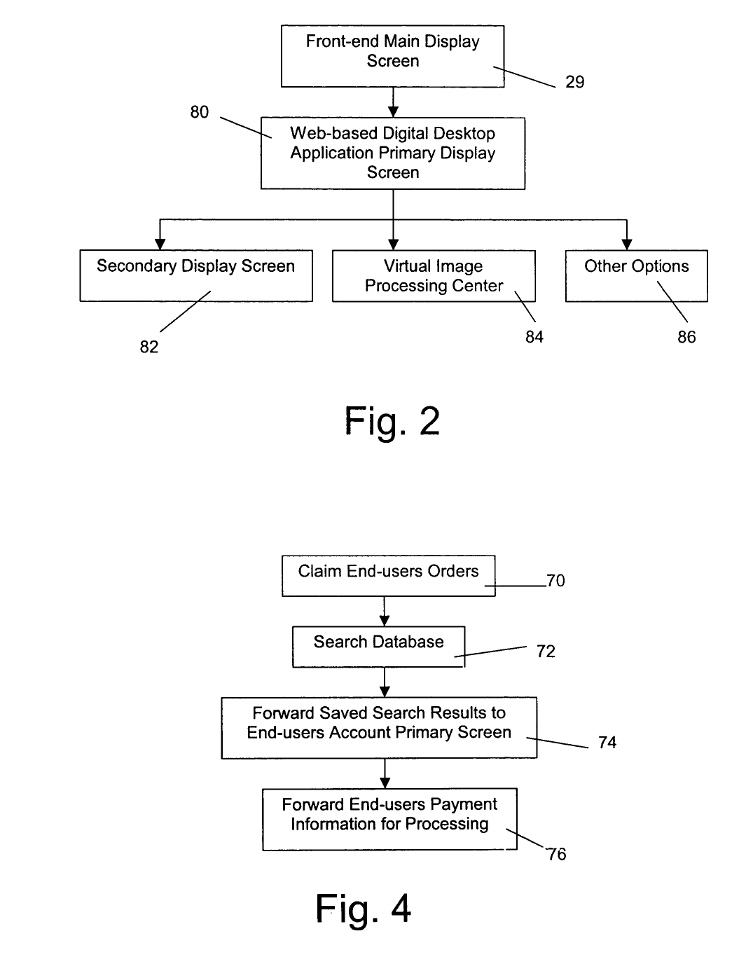

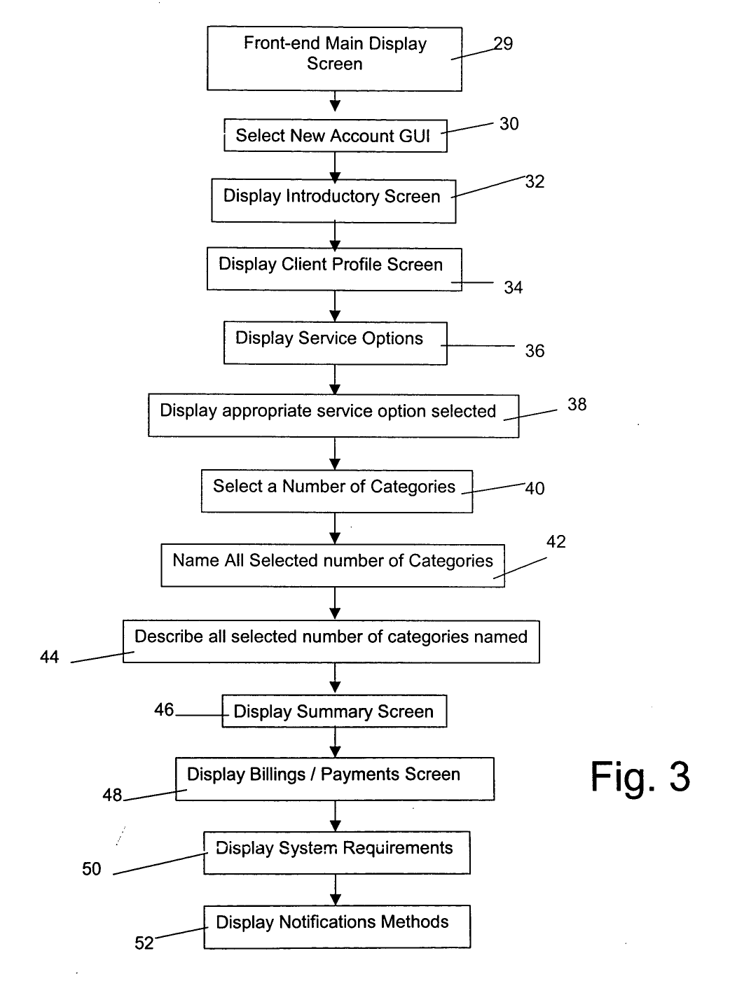

FIG. 2 illustrates the components of a Digital Desktop Application in accordance with one embodiment of the present invention. As described below with respect to FIG. 3, most on-line accounts created include a web-based version of the Digital Desktop Applications program. This program is a digital management system, designed as a presentation and distribution system for content (e.g. images, location information, etc.), which may be applicable to a wide cross section of industries with a variety of functions. The application allows location managers, scouts, film producers, and other members of the media to find and manage filming locations. Users may access the Digital Desktop Application for a limited duration of time.

The organizing and forwarding of collected information by location scouts that use this application is no longer a time-consuming labor intensive task. Location scouts or others using the Digital Desktop Application may easily assemble all updated content (e.g. location information, images, permit information, etc.) forwarded by consultants, in an order that portrays the final image the client intended for the project. This is in contrast to the prior art's use of paper, gluestick and tape to assemble the project. In addition, using the application, location scouts and others may easily distribute all content to their clients in an organized manner. This includes distribution of all jurisdictional ordinance information with respect to every jurisdiction of interest, and any other information requested by clients. The content professionally searched, retrieved, and delivered to the Digital Desktop Application users, and the tools provided by the application automate most of the tasks performed by location scouts and others.

The process of using the applications commences by the user visiting the web-based system 2 of the present invention through an appropriate domain name (IP address) associated with system 2 via the Internet 20. The system applications display a front-end main display screen 29 in the browsers on the output display units of devices 12-18 that includes a variety of resources represented by different GUI icons. Selection of any icon directs users to web page resources pointed to by that icon. Available resources may include a demo to allow new users to learn how to navigate through the site or create a new account, or use other resources available. Included is also an icon that when selected, will direct the user to a sample copy of content available on the database 24, a virtual gallery. Users may select to view the samples in the virtual gallery using their browser on their access unit 12-18.

In addition to the above described resources, the front-end main display screen 29 also includes company and contact information and other resources that are relevant to the industry and the locality of users. Each specific locality will have access to its own front-end main page 29, providing information indigenous to that locality and important for users of that geographic region. Many times film producers are interested in filming at a sunrise or sunset. The main web page 29 enables such users to select through their browsers a related icon, directing them to the sunset/sunrise hours for a particular date and specified location. Provided is also an icon that may be selected that will direct the user to the tide conditions of a body of water. For example, a film maker in southern hemisphere will have access to sunrise/sunsets of that locality, as well as the tide conditions for the beaches in that region. Also provided to user browsers is a glossary of terms that enable users to familiarize themselves with the “jargon” of the industry and the applications 26. The main display 29 also provides icons for other services such as messaging, keeping location information current, location checklist, profile, and so on for location managers. The main display screen 29 is easily extensible to meet the needs of an organization. In addition to all the services, it also allows users to logon to an existing account or create a new one through an appropriate GUI icon.

The primary screen display 80 of the web-based Digital Desktop Application may be accessed by authorized accounts, and is the working palette for reviewing media content. With this screen, users may view, add comment, or add or delete existing content to their application. The ability to add content allows users to upload and add their own set of images, comments, or other information, securely housed on servers. The primary screen 80 includes a set of category folders, with content of those folders created and forwarded by consultants based on the searches conducted. Each Digital Desktop Application created for each account includes a set of tables in the database 24 with data related to the contents in those folders. The data comprises a set of ID values for locations recorded in one or more tables of the database 24, generated as a result of a search. When users select a category folder, the dynamically translated SQL procedures statements use the ID values associated with that category to track and retrieve content (images, locations, descriptions, etc.) from the tables of the database 24, allowing users to view the contents in that category folder. Once open, the contents appear, exposing a main representative image.

Selecting a content (e.g. an image) within a folder initiates a viewer environment, which displays about 20 images or thumbnails of content per screen. Selecting a content enlarges it in a content-viewing field. Selection of the content within the content viewer parameters results in a still larger version of the content appearing in a separate pop-up window. The Digital Desktop Application program, through translated SQL procedural statements uses ID values associated with each content to retrieve a selected content from the Digital Desktop Application tables within the database 24. In the view environment, users may also add comments or notes associated with any selected content, including retrieval of location information. The user may comment on each individual content, and their comments will remain with those contents throughout the program. The comments are stored in one or more tables of the database 24, which are associated with the specific instance of the Digital Desktop Application created for the individual account, and linked to the selected content tables. Dynamically created SQL procedures automatically perform the steps. Each comment may later be selected for viewing in a secondary screen described below. The Digital Desktop Application program provides the user with the capability to show or hide comments and other information.

From the primary screen 80 users may also select to view more details of a selected content (e.g. location information associated with that content). Associated ID values related to location information are stored in location information tables of the Digital Desktop Application. Location information may include, but is not limited to, for example, physical address of a site, permit information, additional categories, access to on-line maps, driving directions, and others such as contact information, including names or telephone numbers of personnel responsible for that location.

The users may further select specific content within the location information for more details. For example, selection of permit information icon enables users to view number and types of permits required. It also enables users to view jurisdictional departments responsible for handling permits or licenses. Addresses, telephone numbers, office hours, and the names of the individuals in charge, permit fees, insurance, or any other jurisdictional ordinance that film maker may require are also available. The Digital Desktop Application may also include links to web sites of various jurisdictions (cities, counties, etc.) for more detailed information, including downloading of permit(s) forms, license(s), or other forms from those sites, if available. Selection of a map icon on Digital Desktop Application primary screen will enable access to maps and driving directions associated with the selected content and its location. The primary screen 80 also includes an additional category(s) forwarded by the consultant that may be of interest to end-users. Access to these categories is similar to those described above.

The secondary display screen 82 of the Digital Desktop Application functions as a virtual screening (or conference) room for further review (or screening) of any selected content by a team of selected participants. This screen helps users to organizing content for viewing by clients during a virtual meeting. This may include appropriate arrangements of content to portray the “story line” that the client intended, their respective locations, location information, and any other information requested by the client. The Digital Desktop Application enables location scouts or others using it the ability to assemble all updated content, and distribute any selected content to selected clients in an organized manner. The capability to use the secondary display screen 82 as a virtual screening and conference room enables all decisions to take place on-line. The application allows the user selection of participants in the virtual conference, the contents that will be presented for screening during the conference, and the ability to vote, add more content, and have dialog between participants—imitating an actual meeting—regardless of the geographic locations of the participants.

The users create the secondary display screen 82 while in the primary screen 80. The first step in preparing the secondary screen 82 involves creating a production team, comprised of selected participants that will attend the virtual screening room. They may most likely include the directors, producers, or others required in the decision making process. The selection of the Edit Set-up GUI icon enables users to “assemble” their team of participants. This selection will launch an edit section, allowing the user to forward invitations to participants of the virtual conference, in addition to enabling the editing of user profile, production profiles, billing information, methods of notification, and others.

To edit (or select) individual members who will attend the screening room, the user selects a team profile GUI icon. This generates a screen with sets of questionnaire, each set related to the profile of a participant. The questions asked include the title (or position) of participants, names, contact information (e.g. email, facsimile, telephone, etc.), and others, for example, special instructions for any one of the participants. Team member profile information allows the user (the host) to identify and track each team member. User may save the information, which will store it in one or more tables of the Digital Desktop Application in database 24 using dynamically generated SQL procedural statements. The database 24 will also generate unique ID values for each member profile saved. The user also has the option of adding new members, if so desired.

The ability to vote, add more content, and have dialogue between participants during the on-line virtual conference or screening room presents visual problems for the host user, as well as the guests (the participant team members). Given that participants to the on-line screening room are most likely located in geographically distant locations and cannot have visual or audio contact with each other, observing and identifying the origins of all user votes, added content, or dialogue or other functions becomes a problem. To overcome this, the Digital Desktop Application generates an icon for each saved team member and the host user. This way, participants may use their icon to vote or add comments, or may select another participant's icon to view that member's comments or keep track of any new added content by a participant. Hence, the icon enables all members to distinguish between one another and visually observe actions taken by any. Of course, other methods of communications are also possible, for example, video-conferencing using the output display units of devices 12-18 illustrated in FIG. 1 in combination with the Digital Desktop Applications' capabilities.

In addition to the selection of each team member (setting profiles of each), the user (host) may also set preferences for each team member. Preferences enable the preferential treatment of one or more members over others. Preferences empower the host to hide or show content(s) and any content related information to any one or more individual participants. For example, detailed information regarding city permits or driving directions may not be of interest to a producer, and may therefore remain hidden from this participant. Virtual Reality views of a location may not be of interest to a location manager but be of great interest to the director—Virtual Reality is a 360-degree interactive panoramic view of a location. To set preferences for each team member, the host user may simply select the name (or the icon) of that member to generate a pop-up window for setting preferences for the selected participant. The host user may select to show or hide any content information desired using various GUI icons on the pop-up window. Once completed, the host may save the preferences set for that member, and begin editing another. Saving the preferences stores the information in one or more tables of the Digital Desktop Application in the database 24, using dynamically generated SQL procedural statements, and generates unique ID values for each saved item.

The final step in preparing the secondary display screen 82 includes forwarding “invitations” to the participants of the virtual conference. To forward invitations, the host user selects a “publish” GUI icon. This step forwards invitations to all participants, using the saved contact information (such as the e-mail addresses) from team member profile tables stored in database 24. In addition, the Digital Desktop Application generates a unique username and password for each team member, and forwards this information with the invitations. All participants will use their username and passwords to login to the secondary display screen 82 of the host user separately or at a specified date and time. This process has the advantage of allowing all images to remain securely within the system, viewed in a controlled environment. When logged-in, all users can view the secondary display screen 82 simultaneously—similar to an actual “screening room” or individually on their own time. Any actions taken by any participants are viewed by all when they refresh their browser. All participants may vote for a content or add comments, and the host may also add more content, and perform other functions during the screening session. For example, all users may view a voting report to see who selected which content, including comments for the voted-on content.

After decisions are made during the virtual conference in the virtual screening room regarding specific content(s), hosts (not guests or secondary users) may forward the selected content(s) to the Digital Desktop Application virtual image processing center (VIPC) 84. The VIPC 84 may be defined as the print shop of the Digital Desktop Application that caters to the printing (or other image processing) requirements of users. The host has the option of forwarding content for personal image processing (e.g. on a PC printer or scanner), or have their documents professionally processed and delivered to them. The personal image processing method provided by VIPC 84 allows the option of custom image processing, whereas the professional image processing method of VIPC 84 allows for both options of custom image processing and quick image processing of content. Custom image processing option of VIPC 84 is a systematic image processing option for users to individually process content from the web site. The quick image processing option allows for automated processing of user's selected content. The use of a GUI icon, available within the primary display screen of the Digital Desktop Application display screens, launches VIPC 84. Therefore, a host user may access VIPC 84 through the primary display screen 80.

The systematic (step-by-step) image processing using the custom image processing option of VIPC 84 commences with a selection of a template. A template enables users to “layout” selected content for further image processing in any manner desired. In general, the selection of the appropriate template will depend on the ordering (or correct layout) of images that best portray the “story line” that, the client intended for the project. Several template options are available to users, including, but not limited to, for example, one-up, one-up plus information or text, two-up, two-up plus information or text, or other configurations such as n-up, n-up plus information or text. The terms one-up, two-up and so on refer to the number of pictures on a page. Users may view detailed information about any template when a pointer mechanism such as a cursor moved by a mouse moves over a template. The information regarding the template may appear in a small pop-up window or may display by other well known-methods. In general, the information may include the maximum number of spaces or blocs available on the template for content (e.g. images), the sizes of the processed content (e.g. printing size), or whether the template allows the addition of text or other information regarding the selected content, such as addresses, permit information, etc.

After selection of a template, the user in the second step selects content in a category for image processing. The available categories may have come from any of the screens of the Digital Desktop Application. The user also has the option to add more categories from any screen for image processing. Selection of a category enables user to view its contents organized in block format. Each content block may include location information, and any other information available with respect to the selection. Selecting a content block enables users to view media(s) of that content. For example, If a selected category has contents concerning restaurants, several media of a selected content block appear when users select that bock. The next step involves the selection of a viewable media associated with the content block. When selected, the borders around the selected media (image) highlight. This will show that the user has used this image in a template, and as additional templates are used, the boarders of the selected media will remain highlighted for the user to track all selected images and avoid repeating the same selections. After the selection of an image, the user must then select a location on the template where the chosen image will reside. Selection of the location on the template will automatically place the chosen image on the specified section of the template, highlighting that region to indicate that it now contains an image. Of course, it would be obvious to use other indication methods. After positioning an image on a specified section of a template, users may add any text thereto. Selection of an appropriate GUI icon to create text launches a text creator screen divided into a header section, a sub-header, and a copy. With this screen users may type a heading, subheading, and copy any text in the appropriate fields provided. The user can copy and paste text from another document or source. The user may also preview the entire page before return to the custom image processing screens to create a new template, preview the template page just created, or print the template page just created.

The quick image processing method of the VIPC 84, available only for professional image processing allows for automatic processing and sorting of content. This processing method arranges, organizes, and places content(s) in preformatted templates, ready for processing. It also provides users the option to remove content already selected for processing. The removal of any selected content generates a “safety” dialog box asking users if they truly wish to delete the content from the process. The quick processing method option will automatically create a document that has the first content of each category in a section cover and the rest of the contents in a template position (two-up, four-up, six-up, etc.). The quick image processing method will automatically place the section cover (one-up plus information) with every new content location selected for processing. Hence, selecting a template that the user wants after the section cover will allow the remaining images to reside on similar templates in the same format. The users must therefore first select an image, then select on a space on a template where they wish the image to reside. This process repeats for all the remaining template pages. After each completed template page, the user has the option of creating a new template page, previewing the just created page, or processing it. Selection of a new template page starts the process again unit the document is completed.

The professional image processing method of VIPC 84 creates a PDF to work on all content (e.g. images), and has the option of watermarking or digitally signing electronic media for protection. The professional image processing will extract HTML content and convert it into PDF formats automatically. It is a method of image processing which will create a PDF for printing, send the PDF to a designated printer, and professionally print the electronic media. This method allows for a tool that will swap lower resolution images for the higher resolution images. This creates high quality representations of the electronic media. The professional processing takes URL to an ASP page, and renders the HTML in a built-in browser. It then reads imbedded HTML comment tags to locate the high-resolution images from the mapped windows server it runs-on, and creates a new HTML file using the high-resolution images. The final product is a PDF with high-resolution image.

Other options 86 available with the Digital Desktop Application may include, but are not limited to, for example, a message center, the ability to submit content (e.g. images), and other elements. The message center is a communication hub for sending and receiving messages to consultants, promoting constant communication between user and consultant. In general, users access the message center through a selection of a GUI icon available on every screen of the Digital Desktop Application, with a history of the messages already sent and forwarded remaining in view for the user convenience.

The ability to submit personal content (e.g. images) to the existing accounts allows users to have a personal library of content for their own use. The steps to upload contents are analogous to those for attaching files to an email. Selection of an appropriate GUI icon for uploading content brings to view a pop up window allowing users to indicate the number of content(s) they would like to “post”. Thereafter, Digital Desktop Application displays a GUI to allow users to select the locations from which desired files will upload. This may include for example a particular storage system of the user computer, such as the hard drive system. The selection of an appropriate storage unit presents the user with a list of files therein recognized by the Digital Desktop Application. Users may select therefrom any desired files for uploading. This will upload the selected files (automatically) to the servers, and store in a location reserved for their account. The user submitted content appears in a separate folder on the Digital Desktop Application.

Other elements of the system may include, for example, an industry availability list (with the ability for individuals to log on and control their availability), an industry onsite procedure checklist, an industry resource list (a directory of industry specific resources), and an informational page which allows the clients or perspective clients to identify misrepresentations in imagery or media (mistakes on the site).

FIG. 3 is a flow diagram illustrating an exemplary procedure for the process of creating a new account initiated by a user through the appropriate hardware and software systems of the present invention illustrated in FIG. 1. Creating an account using the processes illustrated in FIG. 3 allows users full access to the web-based Digital Desktop Application 26, but not the databases 24. The process commences by a user visiting the web-based management system 2 of the present invention through an appropriate domain name (IP address) associated with system 2 via the Internet 20. Any access unit 12-18 may access system 2 over the Internet 20.

A user may create a new account by selecting a new account GUI icon presented to users on the main display screen 29 at step 30. Upon selection, the next step 32 presents users a primary account setup screen that enables them to have a general overview of the steps required to create a new account. This introductory screen at step 32 may for example, include a general description of system 2, type of users mostly interested or using the site, and a general feature list (a summary) of items unique to the site. It also provides contact information if users have questions related to the account setup procedures, an existing account, or other services offered. A start GUI icon on display screen 32 commences initialization of a new account.

Next step 34 presents a set of questionnaire aimed at gathering information regarding the profile of users, including, but not limited to, for example, their contact information. In addition, another GUI on the same screen allows users to enter a password and a username for the new account. Each individual may create different accounts for different projects using different username and password. Hence, each username and password enables access to a separate account, allowing users to manage multiple projects simultaneously.

Upon completing step 34, all user information is saved in one or more tables of database 24 using dynamically generated SQL procedural code. Administrators or others in charge use the profile information, the usernames, and the passwords stored in the database 24 tables to track each individual account. The relational database 24 generates unique identification values (primary keys) as session variables associated with each account, and for each username/password combination for a particular session.

The next step 36 presents users with a services option screen. This screen is comprised of a list of package options designed to suit the needs of most users. It also includes fees associated with each option. The option packages may include, but should not be limited to, for example, a selection of category of content (e.g. images, locations, etc.), selection of a single content (e.g. a single location, image, or others), the use of the web-based Digital Desktop Application, customized search of the database by consultants, and many other options with corresponding fees. A GUI associated with each option package enables the selection of that package. The selected package with its associated fees are written in one or more tables in the database 24, and a unique ID is generated therefor to associate the user profile, username/password, and the selected package option.

After selecting the desired option, step 38 presents a corresponding screen based on that selected option. For simplicity and mere illustration, the exemplary FIG. 3 illustrates the steps for users that have selected the category option. Other options comprise similar steps to setup an account. A category is the grouping of individual content elements. If a category screen displays, step 40 presents a GUI that enables users to select one or more number of categories, in accordance with their project requirements. The selection will cause the database 24 to generate unique ID values for each selected category, and record the results in one or more tables of the database 24 using dynamically generated SQL procedural code. At the next step 42, the users name the selected number of categories. Categories may be named in a variety of ways, including, but not limited to, for example, names based-on subjects of interest, location description, specific name of a location such a building or monument, or any name that helps identify the category. Appropriate GUI on the display screen at step 42 enables users to save their named categories, thereby recording the information on one or more tables of database 24. The database 24 generates unique ID values for each recorded category.

Step 44 presents a display screen that enables users to describe each named category in a designated field. Consultants who search the database 24 may use the names and or descriptions of those categories to conduct searches. Each category named will have a corresponding field for description of that category. When saved, using an appropriate GUI icon displayed on the screen at step 44, the information records on one or more tables of database 24, and unique ID values for each recorded is generated.

Step 46 presents a displayed summary of all the parameters input by users, including for example user profile, package option(s) selected, number of categories selected, name and description of the categories, and all fees associated therewith. At this step, users have the option to change, edit, or delete any categories they have already selected, or add additional categories by selection of a corresponding GUI icon. The displayed screen at step 46 also includes GUI icons for application of all fees to the account. When users select to apply all charges for the account created, a billing/payments screen displays at the next step 48, providing the user with payment options. This screen includes all information usually present in all billing or payment invoice statements, including, but not limited to, for example, an option for form of payment (e.g. credit card). Upon submission of the payment information, the content of the screen is forwarded and recorded in one or more tables of database 24, and unique ID values for the orders in the newly created account are generated.

Step 50 presents users with system requirements for using the site, including required plug-ins for their browsers or other downloads. The next step 52 presents a method of notification screen allowing users to select the format by which they prefer to be notified when their orders are ready. The formats of communicating with users may include, but is not limited to, email, telephone, facsimile, or any others that may be requested by users, such as mail. Dynamically generated SQL procedural statements record the notification method and all information therein (mailing addresses, email, etc) in one or more tables of database 24, and generate a unique ID values therefor.

FIG. 4 is a flow diagram illustrating an exemplary procedure for the method of processing and completing orders by consultants. Search orders from created accounts are forwarded to consultant accounts who search databases 24. The method of processing an order commences in step 70, where the order is claimed (or taken-over) by a consultant. Consultants may use any one of the access units 12-18 illustrated in FIG. 1 to access the databases 24. ASP pages display a list (or table) of orders by their respectively unique order ID values, generated when the order was created in the steps illustrated in FIG. 3. Consultants may claim any order by simply selecting an order from this list. The selection assigns the unique user ID of the consultant to the selected order, enabling administrators to track order processing by consultants. The selection process dynamically generates SQL procedural code to pull all data related to the order from one or more tables of the database 24. The SQL procedures use the unique ID value(s) associated with the selected order to link one or more tables to create a virtual table containing a record-set that contains all relevant information about the order. This may include, but should not be limited to, for example, parameters such as categories of locations, their names and descriptions, or other relevant information provided by user accounts.

After review of the order, at the next step 72 consultants search the automated databases 24 to locate the most pertinent location information, based on the ordered requirements. The classification of data within the database is based on subject matter, with highly descriptive categories to enable quick, targeted search and retrieval of data. To search an image or other media on the database, a consultant uses a key term associated with a subject such as “swimming pool” to retrieve all “swimming pools” available within the database, and further may for example narrow the search by a city name. All content (e.g. images, locations descriptions, etc) have a plurality of keywords or terms associated therewith in one or more tables that provide an accurate description thereof, and help in the classification process.

The database also includes alternative categories for unusual classes of subjects. In addition to a text-based searching, the categories may also be quickly retrieved and selected by a drop down menu or an alphabetic listing of the first letters A through Z of all content. For example, if “park” is a location of interest, the consultant may commence searching by selecting the letter “P” as a starting point.

Regardless of the search method, ASP pages dynamically translated into SQL procedures all searches to link one or more tables of the databases 24 to create a virtual table containing a record-set that contains all relevant information about the search. The record-set is known as the job (or the order) table. This table includes all content ID values, and other ID values that identify the actual content and their stored locations in all the tables. For example, if an image of a restaurant was retrieved, the search result would place the ID value associated with that image, stored in one or more tables, the ID value associated with any description of that restaurant stored in other tables, and ID values for all other information such as jurisdictional ordinances, telephone numbers, maps, driving directions, etc stored in other tables, in the job table.

When the order (or the job) is completed by a consultant, the database will change the order status by changing the status of the job on a job status table from “0” to “1”, indicating that the job is completed. At the next step 74 the consultant forwards the record-set (order table) to a primary screen of the Digital Desktop Application of a user's established account, and notifies the user accordingly. The method of notification at step 76 is in accordance with the instruction information supplied at step 52 when the user created the account.

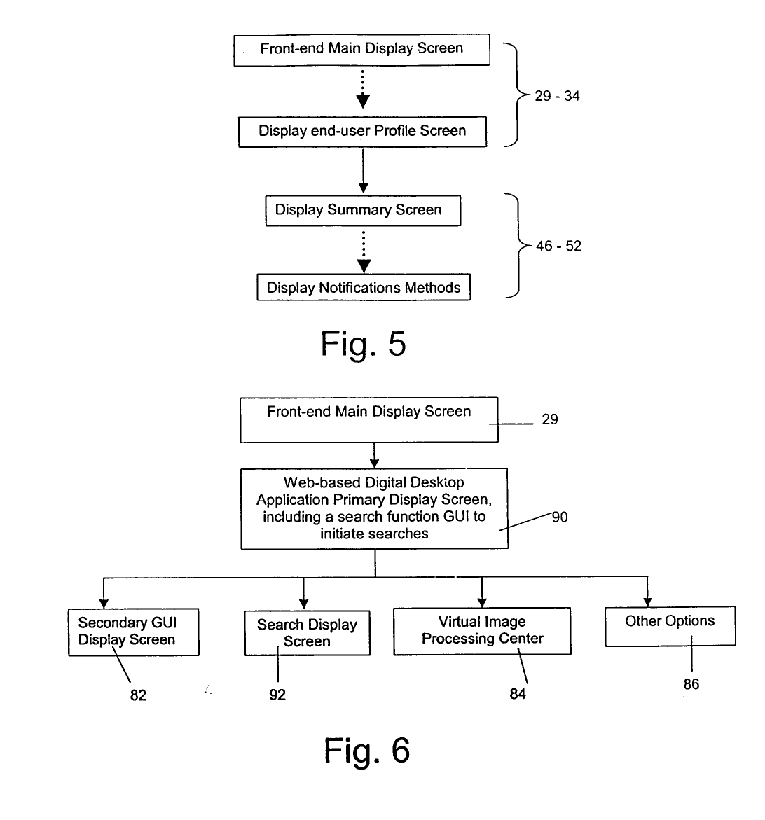

FIG. 5 is a flow diagram illustrating an exemplary procedure for the process of initiating a new user accounts in accordance with a second embodiment the present invention. With this embodiment, the users may have limited authorized access privileges for searching a copy of the databases 24. As illustrated, the initial process steps 29 to 34 and the final process steps 46 to 52 are similar to those described above concerning FIG. 3. The user provides profile information and billing/payment information to create an account to have access to the Digital Desktop Application and searching capabilities. The illustrated exemplary steps 36 to 44 of FIG. 3 are not required when establishing an account in accordance with this embodiment. Consultants, who conducted searches, used information gathered from steps 36 to 44 in searching the database. Therefore, information obtained from steps 36 to 44 will no longer be required because with this embodiment users may conduct searches directly. The processes of creating one or more tables in the database 24 for each account, usernames/password combinations, billing payments, notifications, or others is similar to those described above concerning FIG. 3. Creation of a new account in accordance with this embodiment enable users access to a web-based Digital Desktop Application, in accordance with a second embodiment illustrated in FIG. 6.

In addition to all the capabilities described with respect to the first embodiment of the Digital Desktop Application illustrated in FIG. 2, with this embodiment the user is also provided with the capability to conduct searches using this web-based application. All other components 82, 84, and 86 are identical to those described in relations to FIG. 2, with the exception of a primary screen 90 and a search display screen 92. With this embodiment, users may select a GUI search icon displayed in primary screen 90 to commence search on the database 24. When selected, a search display screen, with appropriate fields to enter search terms is provided where users may type-in search parameters such as location names, type of categories, and so on to retrieve content from the database 24. Just as was done when the consultants performed a search, the ASP pages will dynamically translate the search input into SQL procedural statements and retrieve a record-set from the database into the tables of the Digital Desktop Application. The resulting searched content may then be accessed by a folder icon, similar to those described in relations to FIG. 2. All other functionality will remain the same.

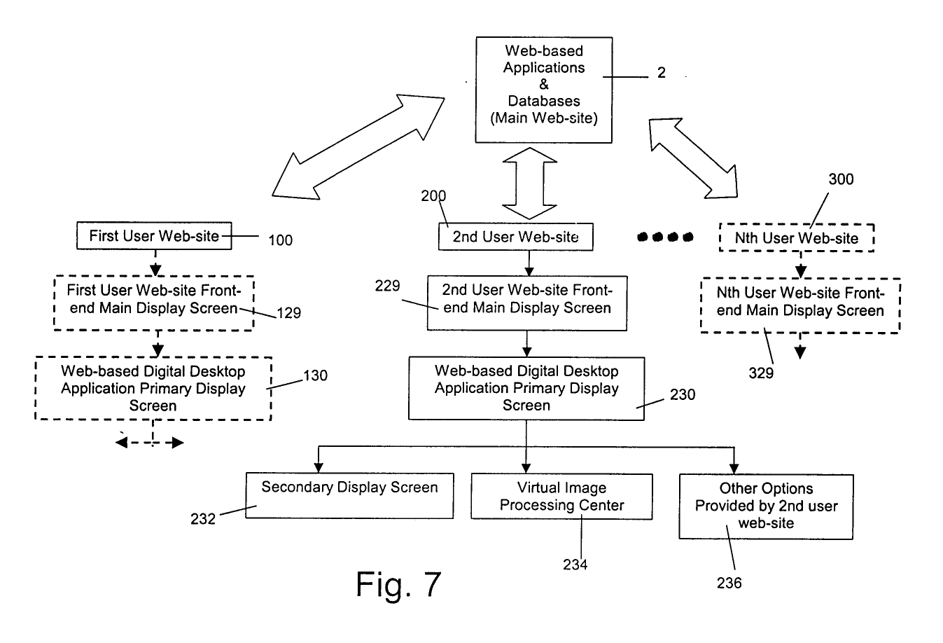

FIG. 7 is an exemplary block diagram illustrating the use of the applications of the present invention on an individual's web-site in accordance with a third embodiment of the present invention. With this embodiment, location scouts or others (professional users) who wish to have access to Digital Desktop Application on their own web-sites 100, 200, 300 may do so by linking them to system 2 of the present invention for a fee. If so desired, a web-site may also be created for these professionals, which will be automatically linked to system 2. In either case, professional users and their clients can have access to a modified version of the Digital Desktop Application. The professional users may also have access to consultants of system 2 for database search services.

The accounts for these users can be setup in a similar manner to that described in relations to FIG. 3. However, the account setup procedure for web-sites created by system 2 would additionally involve setting up professional user's information on their web-site, including, but not limited to, for example, their company name or logo, contact information, etc. The professional users with this embodiment would also be allotted a storage space within system 2 for their use.

The user web-site front-end main display screen 129, 229, 329 may include similar information to that available on the main web-site of system 2 of the present invention, including capability to upload content and save it on the user's allotted storage space. The uploaded content may be organized by the user as a “gallery” of sampled content for their clients to view when visiting their web-site. The operation and use of the entire system illustrated in FIG. 7 is similar to those illustrated and described in relations to FIGS. 2 to 4. The professional users provide detailed information regarding a location to a consultant within system 2 for a search and the consultants forward search results to professional users web-site Digital Desktop Applications for their review. The professional users may review, organize and deliver the search content for automated review by their client using the primary and secondary display screens of their Digital Desktop Application. The web-based Digital Desktop Application primary and secondary display screens have similar capabilities to those described with respect to FIG. 2. The virtual image processing centers provided to professional users within this embodiment have limited capabilities in that they provide personal image processing functionality, only.

In relation to the database 24, the Digital Desktop Applications within this embodiment will operate in the same manner described with respect to other embodiments, except each item stored and retrieved from the database 24 will be “keyed” to be specific to a certain account (user web-site). All relational database programming principles, such as the use of primary or foreign keys, link tables, SQL procedural statements, etc are applicable. For example, when the front-end user web-site page is linked to or created by system 2, the Universal Resource Locator (URL) or pages of that web-site will be provided an ID value by the database 24. The ASP pages may then retrieve content in database 24 using that ID value, so that only data for that user web-site is retrieved from the database 24. The actual SQL procedural statements may be dynamically built and executed directly from the ASP pages or in the relational database 24, similar to those described in relation to FIGS. 2 to 4. Other items, such as name or other co-branding items will dynamically display on the web-sites of end-users based on the ID value. These items will be defined on a table allotted to the user web-site, either manageable by system 2 or the professional users themselves. The professional users may also have limited access to database 24 to record or upload content on database 24 tables allotted to them.

While illustrative embodiments of the invention have been described, numerous variations and alternative embodiments will occur to those skilled in the art. The number, type, combinations and permutations of factors for searching and authoring the content of database, and the determination of best settings thereof will vary depending on the content. The Digital Desktop Applications program is easily extensible and may be varied commensurate with the latest hardware and software updates, including end-user input for improved user-friendly programming interface. In addition, the exemplary structural features and method steps disclosed are merely described as preferred forms of implementing the claimed invention. Furthermore, the terms content or media used throughout the disclosure may be defined, but should not be limited to, for example, images, documents, video, music, text, motion pictures, blueprints, designs, artworks, templates, and others. Such variations and alternate embodiments are contemplated, and can be made without departing from the spirit and the scope of the invention.

What is claimed is:

1. A method of digitally managing a project using a digital application program, comprising:
viewing content that was searched on databases and delivered to a primary display screen of said digital application program;
organizing a secondary display screen of said digital application program for presentation of said content to at least one participant;
allowing access to said secondary display screen for automated review of said content by said at least one participant within said secondary display screen; and
processing a selected set of said content for image processing.

2. A method as recited in claim 1, where said process of viewing content within said primary screen initiates a viewer-display with several thumbnails of contents per screen;
selecting content within said viewer-display enables viewing of said content on a larger scale within a content-viewing field; and
selecting a content within said content-viewing field further enlarges said selected content for a more detailed view.

3. A method as recited in claim 2, where said process of viewing content further comprises selecting information available on said primary display screen, related to said content for a more detailed review of said content.

4. A method as recited in claim 3, where said information comprises of a plurality of jurisdictional ordinance requirements, contact information, maps, and driving directions related to said viewed content.

5. A method as recited in claim 1, where said process of organizing said secondary display screen further comprises adding comments related to said content.

6. A method as recited in claim 5, where said process of organizing said content within said secondary display screen further comprises selecting and organizing of content for presentation;
selecting said at least one participant that will review said organizing content; and
selecting preferences for said at least one participant for selective distribution and viewing of said organizing content by said at least one participant based on selected preferences.

7. A method as recited in claim 6, where said process of allowing access to said secondary display screen further comprises automatically generating and forwarding authorized access credential authentication information to said participants, enabling them access to said secondary screen.

8. A method as recited in claim 1, where said viewed content on said primary screen was searched on a relational database system by consultants, and forwarded to said primary screen.

9. A method as recited in claim 1, where said viewed content on said primary screen was searched on a relational database system by users, and automatically forwarded to said primary screen.

10. A method as recited in claim 1, where said digital application program is a web-based application accessed through a universal resource locator.

11. A method as recited in claim 1, where said digital application program is a web-based application accessed by users through their own web-sites.

12. A method as recited in claim 1, where location scouts perform said viewing and organizing processes.

13. A method as recited in claim 1, where said content is related to information regarding locations and images of said locations.

14. A location scouting method for locating a site, comprising:
placing search orders for searches on a relational database systems having contents related to locations;
searching said relational database systems based on said search orders and forwarding said search results to a primary display screen of a digital application program;
viewing said forwarded contents from said search results on said primary display screen of said digital application program;
organizing a secondary display screen of said digital application program for presentation of said content to at least one participant;
allowing access to said secondary display screen for automated review of said content by said at least one participant within said secondary display screen; and
processing a selected set of said content for image processing.
